(19) United States
(12) Patent Application Publication
(10) Pub. No.: US 2010/0054761 A1
(43) Pub. Date: Mar. 4, 2010

(54) Monolithic coherent optical detectors

(76) Inventors: Young-Kai Chen, Berkeley Heights, NJ (US); Christopher Richard Doerr, Middletown, NJ (US); Vincent Etienne Houtsma, New Providence, NJ (US); Ting-Chen Hu, Edison, NJ (US); Andreas Bertold Leven, Heroldsberg (DE); David Thomas Neilson, Old Bridge, NJ (US); Nils Guenter Weimann, Gillette, NJ (US); Liming Zhang, Marlboro, NJ (US)

Correspondence Address: Alcatel-Lucent;Docket Administrator, Room 2F-192, 600 Mountain Avenue, Murray Hill, NJ, 07974-0636, US

(21) Appl. No.: 12/229,983

(22) Filed: Aug. 28, 2008

(51) Int. Cl. H04B 10/06

(52) U.S. Cl. 398/212

(57) ABSTRACT

An optical receiver has a monolithically integrated electrical and optical circuit that includes a substrate with a planar surface. Along the planar surface, the monolithically integrated electrical and optical circuit has an optical hybrid, one or more variable optical attenuators, and photodetectors. The optical hybrid is connected to receive light beams, to interfere light of said received light beams with a plurality of relative phases and to output said interfered light via optical outputs thereof. Each of the one or more variable optical attenuators connects between a corresponding one of the optical outputs and a corresponding one of the photodetectors.

This application claims the benefit of U.S. provisional Application No. ______, “MONOLITHIC COHERENT OPTICAL DETECTORS”, filed on Aug. 19, 2008, by Young-Kai Chen, Christopher R. Doerr, Vincent Houtsma, Andreas Leven, Ting-Chen Hu, David T. Neilson, Nils G. Weimann, and Liming Zhang.

### BACKGROUND

1. Technical Field

The invention relates generally to optical data communications and, more particularly, to apparatus and methods for optical receivers.

2. Discussion of the Art

This section introduces aspects that may be helpful to facilitating a better understanding of the inventions. Accordingly, the statements of this section are to be read in this light and are not to be understood as admissions about what is prior art or what is not the prior art.

Some bandwidth-efficient optical modulation schemes use phase-shift keying rather than simple on-off keying to modulate data onto an optical carrier. In such schemes, the optical receiver may use an optical local oscillator to demodulate the data from a received modulated optical carrier. The local oscillator provides a reference signal that is used to down mix the modulated optical carrier, e.g., to the baseband.

In such schemes, an optical receiver may include optical beam splitter(s), 90° optical hybrid(s), an optical local oscillator, and photodetectors. The optical beam splitter(s) may separate different polarization components of the incident light beam(s) based on polarization for independent processing. The optical hybrid(s) may optically mix the received modulated optical carrier with the coherent light from the optical local oscillator to produce down mixed optical signals. The photodiodes can detect intensities of such down mixed optical signals to produce electrical signals usable to recover data carried by the received modulated optical carrier.

### BRIEF SUMMARY

Various embodiments provide coherent optical receivers on planar substrates, methods of fabricating such optical receivers, and/or methods of operating such optical receivers. The coherent optical receivers may monolithically integrate optical components that optically mix a modulated optical carrier with an optical reference carrier and electronic components that detect in-phase and quadrature-phase data streams carried by the modulated optical carrier from the signals produced by the optical mixing.

In first embodiments, an optical receiver has a monolithically integrated electrical and optical circuit that includes a substrate with a planar surface. Along the planar surface, the monolithically integrated electrical and optical circuit has, at least, an optical hybrid, one or more variable optical attenuators, and photodetectors. The optical hybrid is connected to receive light beams, to interfere light of said received light beams with a plurality of relative phases and to output said interfered light via optical outputs thereof. Each of the one or more variable optical attenuators connects between a corresponding one of the optical outputs and a corresponding one of the photodetectors.

In some specific first embodiments, the integrated electrical and optical circuit includes a polarization beam splitter located along the surface and an optical local oscillator. The integrated electrical and optical circuit is connected to receive light from said optical local oscillator such that the polarization beam splitter splits said light into two light beams. The integrated electrical and optical circuit is configured to perform said splitting without exchanging energy of said received light between transverse electric and transverse magnetic polarization modes.

In some specific first embodiments, the optical receiver includes a feedback controller connected to operate the variable optical attenuators to compensate a difference between a time-averaged light intensity delivered to one of the photodetectors by a first of the optical outputs of the optical hybrid and a time-averaged light intensity delivered to another of the photodetectors by a second of the optical outputs of the optical hybrid.

In some specific first embodiments, the optical hybrid includes a planar multi-mode interference device configured to output light intensities at different optical outputs thereof such that the light intensities are indicative of different first and second phase components of a modulated optical carrier received by the optical receiver. The first optical receiver may also include a feedback controller connected to operate a phase shifter in the optical hybrid in a manner that reduces an imbalance between time-averages of measurements of light intensities of in-phase and quadrature-phase components by the photodetectors.

In some specific first embodiments, the monolithically integrated electrical and optical circuit includes, along the planar surface, a pair of polarization beam splitters, a second optical hybrid, one or more second variable optical attenuators; and second photodetectors. Each of the second variable optical attenuators connects between a corresponding optical output of the second optical hybrid and a corresponding one of the second photodetectors. Each optical hybrid is connected to receive light from both polarization beam splitters. Each optical hybrid may also be configured to output one or more light beams whose intensities are indicative of data modulated onto an in-phase component a modulated optical carrier received by the optical receiver and onto a quadrature-phase component of the modulated optical carrier.

In second embodiments, an optical receiver includes a planar substrate having multiple layers of semiconductor located on a surface thereof. The layers are patterned to form, over the surface, two optical hybrids, a plurality of variable optical attenuators; and a plurality of photodetectors. Some of the optical outputs of the optical hybrids are connected to corresponding ones of the photodetectors via the variable optical attenuators. The optical hybrid and the variable optical attenuators include a vertical p-n, n-p, n-i-p, or p-i-n doped semiconductor layer structure therein.

In some specific second embodiments, the variable optical attenuators include the vertical sequence of semiconductor alloys of the optical hybrids.

In some specific second embodiments, the doped semiconductor layer structures of the optical hybrid and the variable optical attenuators are transparent to light at C-band telecommunications wavelengths in the absence of biasing.

In some specific second embodiments, the photodetectors are photodiodes including a plurality of the semiconductor layers in the semiconductor layer structure in the optical hybrids.

In some specific second embodiments, the optical receiver includes first and second polarization beam splitters located along and over the surface. Each polarization beam splitter is configured to transmit one polarization component of light received therein to a first of the optical hybrids and is configured to transmit another polarization component of light received therein to a second of the optical hybrids.

In third embodiments, an optical receiver includes a monolithically integrated electrical and optical circuit having a substrate with a planar surface. The circuit includes two polarization beam splitters, two optical hybrids, and photodetectors located along the surface. Each optical hybrid is connected to receive light beams from both polarization beam splitters, to interfere light of said received light beams and to output said interfered light via optical outputs thereof to some of the photodetectors. Each polarization beam splitter includes an interferometer. The interferometer includes an input optical coupler, an output optical coupler, and two internal optical waveguides connecting optical outputs of the input optical coupler to corresponding optical inputs of the output optical coupler. The two optical waveguides have different lateral widths.

In some specific third embodiments, the interferometer is configured to emit one polarization mode at one optical output thereof and to emit a different polarization mode at another output thereof.

In some specific third embodiments, one of the optical hybrids includes a planar multi-mode interference device configured to output light intensities at different optical outputs thereof. The light intensities are indicative of different first and second phase components of a modulated optical carrier received by the optical receiver.

In some specific third embodiments, the optical hybrids include a vertical p-n, n-p, n-i-p, or p-i-n doped semiconductor layer structure therein.

In fourth embodiments, an optical receiver includes a monolithically integrated electrical and optical circuit having a substrate with a planar surface. Along the surface, the monolithically integrated electrical and optical circuit includes two polarization beam splitters, two optical hybrids, and photodetectors. The optical receiver includes an optical local oscillator. The circuit is connected to receive a reference optical carrier from the optical local oscillator in a polarization mode not aligned with either polarization splitting axis of one of the polarization beam splitters that is connected to receive the reference optical carrier.

In some specific fourth embodiments, a part of the monolithically integrated electrical and optical circuit that receives the reference optical carrier from the optical local oscillator and separates different polarization modes thereof is configured to not substantially transfer light energy thereof between a transverse magnetic mode and a transverse electric mode.

In some specific fourth embodiments, each optical hybrid is connected to receive light beams from both polarization beam splitters, to interfere light of said received light beams, and to output said interfered light via optical outputs thereof.

In some specific fourth embodiments, one of the optical hybrids includes a planar multi-mode interference device configured to output light intensities at different optical outputs thereof. The light intensities are indicative of different first and second phase components of a modulated optical carrier received by the optical receiver.

### BRIEF DESCRIPTION OF THE DRAWINGS

Various embodiments are described in the Figures and Detailed Description of the Illustrative Embodiments. Nevertheless, the invention may be embodied in various forms and is not limited to the embodiments described in the Figures and Detailed Description of the Illustrative Embodiments.

FIG. 1A is a top view schematically illustrating one embodiment of an optical receiver that is configured for coherent optical detection;

FIG. 1B is a top view schematically illustrating an interferometer embodiment of a polarization beam splitters (PBS), e.g., suitable for the PBSs of FIG. 1A;

FIG. 1C is a circuit diagram illustrating one embodiment of an operating circuit for a pair of photodiodes that differentially detect light intensities from optical outputs of an optical hybrid, e.g., for use with the optical hybrids of FIG. 1A;

FIG. 2A is a cross-sectional view illustrating portions of one embodiment of the passive optical waveguides of FIG. 1, e.g., along lines O-O, A-A, B-B, and/or C-C therein;

FIG. 2B is a cross-sectional view illustrating one embodiment of a variable optical attenuator of FIG. 1, e.g., along line D-D therein;

FIG. 2C is a cross-sectional view illustrating one embodiment of the photodetectors of FIG. 1, e.g., along lines E-E and/or F-F therein;

FIG. 3A is a top view illustrating one embodiment of an optical hybrid, e.g., the optical hybrids of FIG. 1A;

FIG. 3B is a top view illustrating another embodiment of an optical hybrid, e.g., the optical hybrids of FIG. 1A;

FIG. 4A is a cross-sectional view illustrating a specific embodiment of the passive optical waveguides of FIGS. 1A and 2A;

FIG. 4B is a cross-sectional view illustrating one embodiment of the photodetectors of FIGS. 1A and 2C; and

FIG. 5 is a top view of a part illustrating a portion of one embodiment of the optical receiver of FIG. 1.

In the various Figures, like reference numerals and symbols indicate elements with similar or the same function.

In some Figures, relative sizes of some features may be exaggerated to better illustrate the embodiments to those of skill in the art.

### DETAILED DESCRIPTION OF ILLUSTRATIVE EMBODIMENTS

It will be useful to discuss some polarization propagation modes of light in planar structures described herein. Thus, transverse electric (TE) light will refer to the lowest propagating mode in which the electric field of the light is perpendicular to the direction of propagation and is also typically substantially parallel to the adjacent planar surface of the substrate. Also, transverse magnetic (TM) light will refer to the lowest propagating mode in which the magnetic field of the light is perpendicular to the direction of propagation, and is also typically substantially parallel to the adjacent planar surface of the substrate. TE light and TM light typically form orthogonal propagation modes in planar waveguide structures.

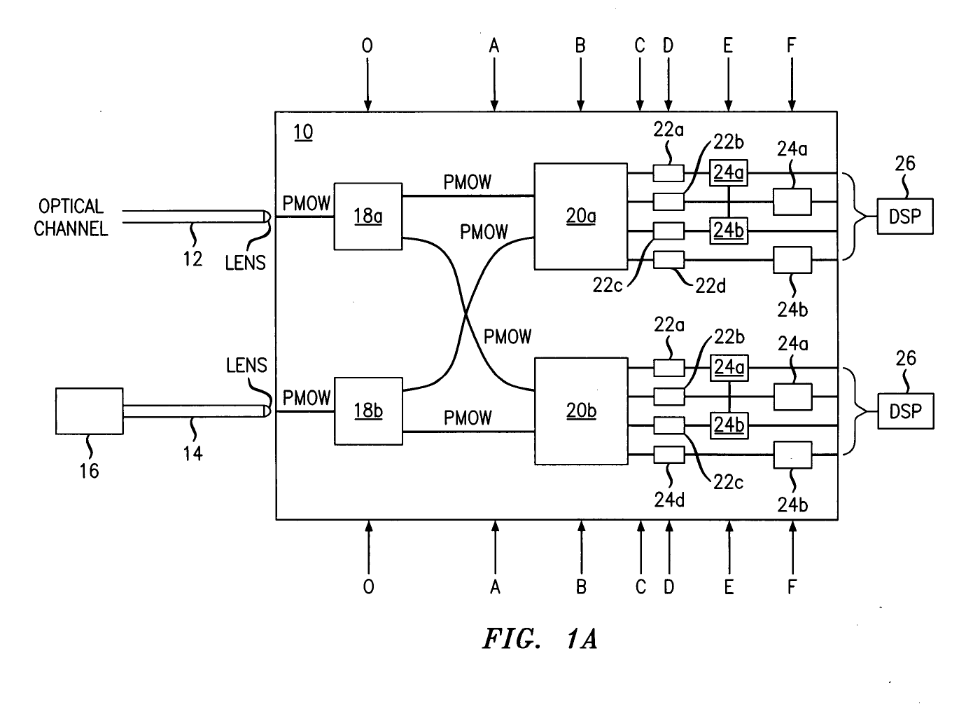

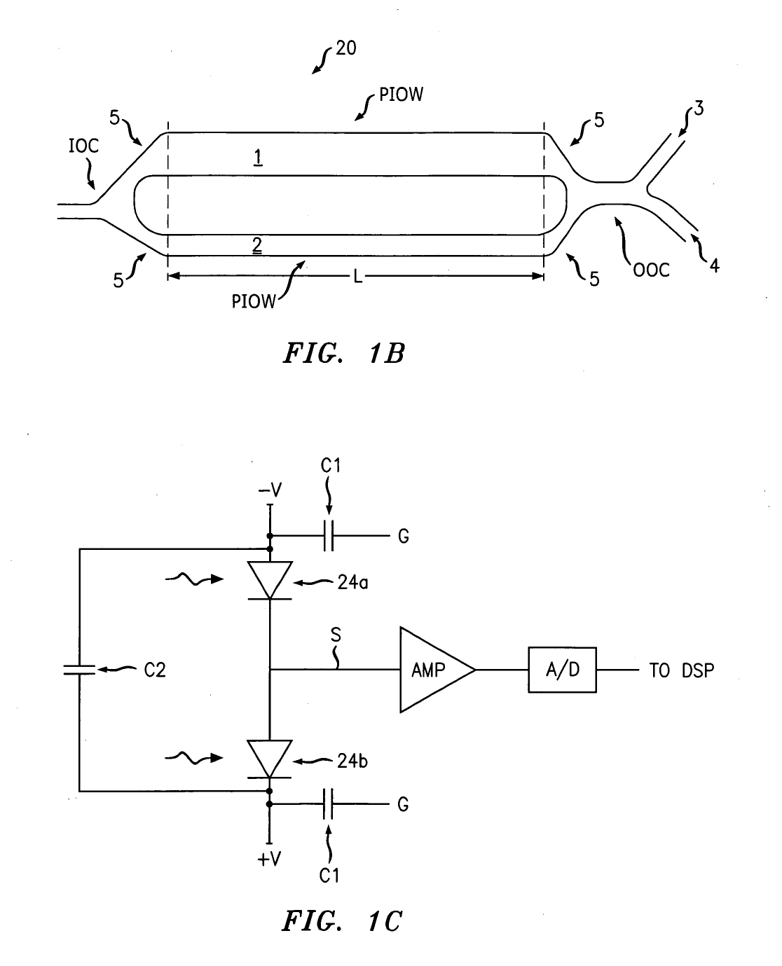

FIG. 1A shows an example of an optical receiver 10 that is configured to perform coherent optical detection of two different polarization components of a received modulated optical carrier, e.g., orthogonal TE light and TM light. In some embodiments, the optical receiver 10 may be configured to operate as a polarization-diverse device that decodes a received modulated optical carrier in a manner that is substantially independent of the substantial plane polarization of the received modulated optical carrier. In some other embodiments, the optical receiver 10 may be configured to independently decode first and second data streams that were separately modulated onto two orthogonal plane polarization components of the optical carrier.

In yet other embodiments, the optical receiver 10 may be configured to decode only a single polarization component of a received modulated optical carrier, e.g., and not include polarization beam splitters (PBSs) 18a, 18b.

The optical receiver 10 receives a modulated optical carrier from a first optical waveguide 12 and receives a reference optical carrier from a second optical waveguide 14. The modulated optical carrier may be delivered by the first optical waveguide 12 from an optical communications line. The reference optical carrier may be delivered by the second optical waveguide 14 from an optical local oscillator 16. The optical local oscillator 16 may include, e.g., a laser that generates coherent continuous-wave light for the reference optical carrier at about the wavelength of the modulated optical carrier received from the first optical waveguide 12. Indeed, the optical local oscillator 16 may or may not be phase and/or frequency locked to the modulated optical carrier.

The first optical waveguide 12 may be, e.g., a standard transmission optical fiber that supports single-mode operation at C-band and/or L-band telecommunications wavelengths. The first optical waveguide 12 may be, e.g., end-coupled to the optical receiver 10 via a collimating lens.

The second optical waveguide 14 may deliver the reference optical carrier to the optical receiver 10 in a selected plane polarization state, e.g., a rotation of TM light and TE light. For example, the second optical waveguide 14 may be, e.g., a polarization maintaining optical fiber or a sequence of spliced polarization maintaining optical fibers. The second optical waveguide 12 may also end-couple to the optical receiver 10 via a collimating lens. The second optical waveguide 14 receives light from the optical local oscillator 16, e.g., at a second end of the second optical waveguide 14.

The optical receiver 10 includes a monolithically integrated electrical and optical circuit located along a planar surface of a substrate. The integrated electrical and optical circuit may include polarization beam splitters (PBSs) 18a, 18b; optical hybrid(s) 20a, 20b; variable optical attenuators 22a, 22b, 22c, 22d; and photodetectors 24a, 24b, and, e.g., may include electronic transimpedance amplifiers.

In embodiments having the PBSs 18a, 18b, the first PBS 18aconnects, e.g., via a polarization maintaining optical waveguide (PMOW), to receive the modulated optical carrier from the first optical waveguide 12, and a second PBS 18b similarly connects to receive the light of the optical local oscillator 16 via the second optical waveguide 14.

The second optical waveguide 14 may be configured to deliver light to the monolithically integrated electrical and optical circuit in a specific plane polarization state. In particular, the optical components of the monolithically integrated electrical and optical circuit typically will not rotate the polarization state of such received light. For example, the polarization maintaining optical waveguides (PMOWs); the polarization beam splitters (PBSs) 18a, 18b; the optical hybrid(s) 20a, 20b; and the variable optical attenuators 22a, 22b, 22c, 22d do not typically perform such rotations. That is, the monolithically integrated electrical and optical circuit and the second PBS 18b are configured to not substantially transfer light energy externally delivered to the second optical waveguide 14 between a transverse magnetic mode and a transverse electric mode. For that reason, delivering the reference optical carrier in a special polarization state may desirably and predictably affect the processing of a modulated optical carrier by the monolithically integrated electrical and optical circuit.

One desirable delivery mode aligns the polarization of the delivered reference light carrier at an angle of about 45 degrees with respect to the polarization axes of the second PBS 18b. For example, the second optical waveguide 14 may deliver the reference optical carrier to the PBS 18b with a polarization tilted by about 45 degrees, e.g., about 40 to 50 degrees, with respect to the polarization axes of the PBS 18b. For such a delivery configuration, the PBS 18b will typically send about equal light intensities to each of its optical outputs.

To produce the above configuration, the optical local oscillator 16 may be aligned to transmit light to the second optical waveguide 14 with a polarization that is aligned along one polarization axis therein, and that polarization axis of the second optical waveguide 14 may be tilted by about 45 degrees with respect to the polarization axes of the lower PBS 18b. Alternatively, a first segment of the second optical waveguide 14 may have its polarization axes aligned with those of the PBS 18b, but be excited to carry light of the reference optical carrier that is polarized at about 45 degrees with respect to the polarization axes of the second optical waveguide 14. Such an excitation may be produced by aligning the optical local oscillator 16 to transmit light that is polarized along a polarization axis of a second segment of polarization maintaining fiber where the second segment is spliced to the first segment so that the polarization axes of the two segments are relatively tilted by about 45 degrees, e.g., 40 degrees to 50 degrees.

If optical components of the planar optical circuit have insertion losses that are polarization dependent, the tilt of the polarization of the delivered reference optical carrier with respect to the pure polarization axes of the PBS 18b may be adjusted to be away from 45 degrees. In particular, the tilt may be set to couple more light into that polarization component that suffers the highest loss in the planar optical circuit. Such a tilt can help to balance the intensities of the two polarizations of the reference optical carrier when mixed with the modulated optical carrier in the planar optical circuit.

FIG. 1B illustrates an example of a planar PBS 18 that may be suitable for the PBSs 18a, 18b of FIG. 1A. The planar PBS 18 includes a 1×2 input optical coupler (IOC) a 2×2 output optical coupler (OOC), and first and second passive internal optical waveguides (PIOW) that individually connect optical outputs of the input optical coupler IOC to optical inputs of the output optical coupler OOC. The input and output optical couplers may have, e.g., the form of conventional 50/50 power optical couplers. The first and second passive internal optical waveguides PIOW have long first and second segments 1, 2 with different lateral widths. The passive internal optical waveguides PIOW also include optical transition regions 5 that adiabatically connect the segments with the different lateral widths to the optical couplers IOC, OOC.

The differences in lateral widths of the first and second segments 1, 2 produce different relative optical path lengths for TE light and TM light in the first and second passive internal optical waveguides PIOW. Between these two optical waveguides, the relative optical path length difference for TE light minus the relative optical path difference for TM light is about equal to L[(n_{TE}−n_{TM})₁−(n_{TE}−n_{TM})₂]. Here, L is length of the first and second segments 1, 2 of the passive internal optical waveguides PIOW, n_{TE} and n_{TM} are the refractive indices of respective TE and TM light therein, and the subscripts “1” and “2”, i.e., in n_{TE1}, n_{TE2}, n_{TM1}, and n_{TM2}, refer to the first and second passive internal optical waveguides PIOW, respectively.

In the PBS 18, the length L and widths of the first and second segments 1, 2 are selected to produce desired relative phase differences between light that interferes in the output optical coupler OOC. In particular, the relative phase differences are selected so that a first optical output 3 of the PBS 18 emits substantially only TE light to a second optical output 4 of the PBS 18 emits substantially only TM light in a selected wavelength band. For light in the C-band of telecommunications, such a desired separation of TE light and TM light can be achieved if the ridge of the first segment 1 has a lateral width of about 1.5 to 2.5 microns, e.g., 2 microns, and the ridge of the second segment 2 has a lateral width of about 3.5 to 4.5 microns, e.g., 4 microns. Such core widths can produce refractive index differences for TE light and TM light between the segments 1, 2 of about 2.5×10⁻³. Then, the length, L, of the segments 1, 2 is selected so that TM light interferes destructively in the first optical output 3 of the output optical coupler OOC and TE light interferes destructively in the second optical output 4 of the output optical coupler OOC. Thus, the length, L, and widths of the segments 1, 2 are selected to cause the PBS 18 to function as a polarization mode separator.

Some similar or identical structures for PBSs and/or methods of making and/or using such PBSs may be described in U.S. patent application Ser. No. ______ titled “PLANAR POLARIZATION SPLITTER”, which was filed on Aug. 19, 2008, by Christopher Doerr. This patent application is incorporated herein by reference in its entirety.

In other embodiments, other planar constructions known to those of skill in the art may be used to make the polarization beam splitters 18a, 18b of FIG. 1A.

The optical outputs of the PBSs 18a, 18b connect to the optical inputs of the optical hybrids 20a, 20b, e.g., via polarization maintaining optical waveguides (PMOWs).

Each optical hybrid 20a, 20b has two optical inputs and two pairs of optical outputs and is configured to mix a polarization mode of light of the reference optical carrier, which is received on one optical input, with the same polarization mode of light of the modulated optical carrier, which is received on the other optical input. That is, each optical hybrid 20a, 20b is connected to receive and interfere substantially the same polarization mode of light from corresponding outputs of the two PBSs 18a, 18b. For this reason, each PBS 18a, 18b may be configured to provide a high purity polarization mode on one optical output thereof. For example, the PBS 18amay be configured to produce high purity of TE light on the optical output coupled to the first optical hybrid 20a, and the PBS 18b may be configured to produce high purity of TM light on the optical output coupled to second optical hybrid 20b. Such a design for the PBSs 18a, 18b may be useful to ensure that light output by each optical hybrid 20a, 20b provides a measurement of a single polarization mode. In the PBS 18 of FIG. 1B, such selective high output polarization purities may be produced, e.g., by slightly adjusting relative lengths of the two segments 1, 2 of the passive internal optical waveguides PIOW.

Each optical hybrid 20a, 20b is configured to emit at a first pair of optical outputs light intensities whose difference is about proportional to an intensity of the in-phase component of the relevant polarization mode of the modulated optical carrier and to emit at a separate second pair of optical outputs light intensities whose difference is about proportional to an intensity of the quadrature-phase component of the same polarization mode of the modulated optical carrier. That is, for an optical local oscillator frequency and phase matched to the received modulated optical carrier, one pair of optical outputs enables differential detection of the in-phase component of the modulated optical carrier, and the other pair of optical outputs provides for the differential detection of a relatively 90 or 270 degrees delayed phase component, i.e., the quadrature-phase component of the modulated optical carrier.

In some alternate embodiments, the optical hybrids 20a, 20b may be constructed in a manner suitable for single-ended detection (not shown). In such an embodiment, the light intensity from a first optical output of each optical hybrid 20a, 20b is about proportional to the intensity of the in-phase component of one polarization mode of the received modulated optical carrier. In such an embodiment, the light intensity output by a second optical output of each optical hybrid 20a, 20b is about proportional to an intensity of the quadrature-phase component of the same polarization mode of the modulated optical carrier.

Each optical hybrid 20a, 20b has optical outputs where the light of the received modulated optical carrier and reference optical carrier interfere. At a pair of optical outputs or a single optical output, e.g., of alternate single-ended embodiments, the interference produces light whose intensity is a measure of one phase component of the modulated optical carrier. At the other pair of optical outputs or single optical output (not shown), the interference is performed with a different relative phase difference, e.g., a relative phase of about 90 degrees, so that the light intensity there provides a measure of the other phase component of the modulated optical carrier. For example, the two measured phase components may be the in-phase and quadrature-phase components of the modulated optical carrier.

Some or all of the optical outputs of the optical hybrids 20a, 20b may serially connect to corresponding variable optical attenuators (VOAs) 22a, 22b, 22c, 22d. The VOAs 22a-22d enable the adjustment of light intensities produced at individual ones of the optical outputs. For example, each optical output of the optical hybrids 20a, 20b may connect to a separate VOA 22a-22d as illustrated in FIG. 1A so that the light intensities from the set of optical outputs may be individually adjusted to be substantially equal, e.g., in response to any set of time-averaged light intensities in the individual optical waveguides transmitting light to the VOAs 22a-22d. Such a configuration of the VOAs 22a-22d can be configured to correct variations in relative light intensities emitted by the optical outputs of the optical hybrids 20a, 20b where the variations are caused by manufacturing errors and/or by use-related aging of the optical receiver 10.

Examples of the VOAs 22a-22d include vertical structures for photodetectors that can be electrically operated to provide varying amounts of optical attenuation. In such vertical structures, a voltage can be applied across the waveguide ridge to shift a band edge of a layer of the waveguide ridge so that the bandgap is smaller than an energy of single photons of the light being processed by the optical receiver 10 thereby causing optical absorption in the layer.

Each photodetector 24a, 24b is located and configured to detect a light intensity that is emitted by a corresponding optical output of one of the optical hybrids 20a, 20b. The individual photodetectors 24a, 24b may be, e.g., phototransistors or photodiodes. The photodetectors 24a, 24b may be connected in pairs, e.g., sequentially connected photodiodes, to provide differential detection of the light intensity from each pair of corresponding optical outputs of the optical hybrids 20a, 20b. Alternately, the photodetectors 24a, 24b may also be single-ended photodiodes or phototransistors that are connected to enable direct measurement of light intensities emitted by individual ones of the optical outputs of the optical hybrids 20a, 20b (not shown).

In various embodiments, the photodetectors 24a, 24b measure light intensities that enable the detection of data that is modulated on different phase components of the received modulated optical carrier, e.g., the in-phase and quadrature-phase components. The photodetectors 24a, 24b connected to optical outputs of the different optical hybrids 20a, 20b measure light intensities corresponding to the data modulated onto different polarization modes of the received modulated optical carrier, e.g., the TE mode and the orthogonal TM mode.

The photodetectors 24a, 24b can connect to circuitry for processing measurements thereof, e.g., analog-to-digital converters (not shown) and digital signal processor(s) (DSP(s)) 26 in various ways. First, the circuitry may provide for polarization-diverse detection and decoding of the data stream carried by the received modulated optical carrier. Second, the circuitry may alternately provide for detection and decoding of independent data streams that are modulated onto different polarization modes of the received modulated optical carrier, e.g., the TM mode and the TE mode.

FIG. 1C shows one embodiment of an operating circuit for one embodiment of the photodetectors 24a, 24b of FIG. 1A. In this embodiment, each photodetector 24a, 24b is a photodiode, and the photodiodes are connected into serially connected pairs that provide for differential detection of light from the optical outputs of the optical hybrids 20a, 20b. In each serially connected pair, outside terminals connect across a DC voltage driver, i.e., illustrated as ±V terminals. The outside terminals of each serially connected pair also connect to ground (G) via DC isolation capacitors C1. The DC isolation capacitors C1 may be shared between different pairs of serially connected photodiodes 24a, 24b. The outside terminals may also connect each pair of serially connected photodiodes 24a, 24b across a capacitor C2 that cuts off the detection of high frequency signals. The capacitor C2 may also be shared between different such pairs of serially connected photodiodes 24a, 24b. The terminal, S, between the serially connected photodiodes 24a, 24b of each pair carries a current indicative of the difference between the light intensities detected by the photodiodes 24a, 24b of the pair. This terminal may connect to an electrical amplifier (AMP), e.g., a transimpedance electrical amplifier to provide an electrical output signal. The electrical amplifier (AMP) may transmit said electrical output signal to an analog-to-digital converter (A/D) for digitization prior to processing by the DSP 26, e.g., to decode a data stream from the digitized sate signal.

Referring again to FIG. 1A, due to the lack of perfect frequency, phase, and/or polarization matching between the reference optical carrier and the received modulated optical carrier, the digital signal processor(s) DSP(s) 26 may also be configured to compensate for the lack of such perfect frequency, phase, and/or polarization matching. For that reason, the DSP(S) 26 may receive amplified and digitized electrical output signals from the corresponding sets of photodetectors 24a, 24b and perform such compensation on said digital electrical output signals. Examples of designs for such DSPs 26 may be found in one or more of U.S. patent application Ser. No. 11/644,555 filed Dec. 22, 2006 by Ut-Va Koc; U.S. patent application Ser. No. 11/204,607 filed Aug. 15, 2005 by Young-Kai Chen et al; and U.S. patent application Ser. No. 11/644,536 filed Dec. 22, 2006 by Young-Kai Chen et al. These three patent applications are incorporated herein by reference in their entirety.

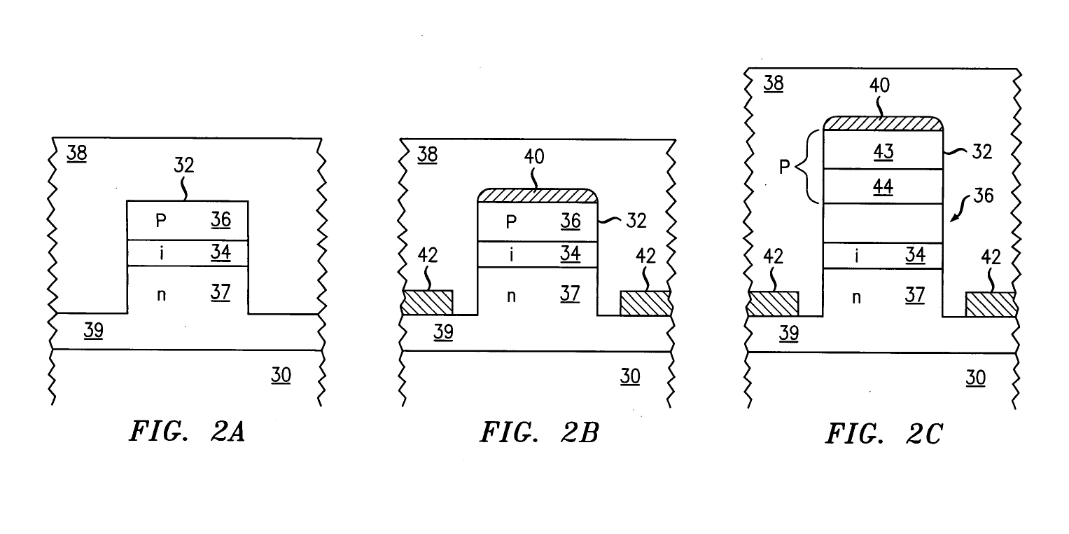

The optical receiver 10 may include a planar optical and electrical integrated circuit that monolithically integrates the PBSs 18a, 18b, optical hybrids 20a, 20b, VOAs 22a-22d, and photodetectors 24a, 24b in a layered structure over a single semiconductor or dielectric planar substrate 30 as illustrated by FIGS. 2A, 2B, and 2C. Other related electrical circuitry, e.g., electrical amplifiers (AMP), analog-to-digital converters (A/D) and DSP(s) as illustrated in FIGS. 1A-1C may or may not be monolithically integrated over the same substrate 30. The fabrication of such mixed electrical and optical circuits in a monolithic integrated form can improve production yields and/or reduce fabrication costs of the coherent optical detector 10.

FIG. 2A illustrates an example of a vertical layer structure for the passive and polarization maintaining planar optical waveguide portions of the optical receiver 10 of FIG. 1A, e.g., along cross sections O-O, A-A, B-B, and C-C therein. Each planar optical waveguide may have the form of a ridge 32 that is located over the substrate 30. Each ridge 32 includes an optical core layer 34 and top and bottom optical cladding layers 36, 37. The ridge 32 may be covered by an outer optical cladding layer 38 that is, e.g., planarized to produce a flat top surface for the optical receiver 10.

The ridge 32 includes a plurality of compound semiconductor alloys in its various layers 34, 36, 37. The ridge 32 has the vertical structure of an electrical diode, e.g., due to appropriate doping. While the top-to-bottom vertical doping structure is illustrated in FIG. 2A as p-type (p)/intrinsic (i)/n-type (n), other embodiments may have other top-to-bottom vertical doping structures, e.g., p-n, n-i-p, or n-p. Also, the upper semiconductor portion 39 of the substrate 34 may be a p-type or n-type layer as appropriate. The outer optical cladding layer 38 may be any optically transparent material of lower refractive index than the semiconductor of the ridge 32, e.g., benzocylcobutene (BCB) polymer, doped or undoped silica glass, or silicon nitride. The outer optical cladding layer 38 may have been planarized by a conventional process such as chemical-mechanical polishing (CMP) to produce a flat exposed surface thereon.

FIG. 2B illustrates a cross-section of the vertical layer structure of one of the variable optical attenuators (VOAs) 22a-22d of FIG. 1A, e.g., along cross section D-D. The VOAs 22a-22d may have substantially the same vertical layer structure as the passive optical waveguides as shown in FIG. 2A. In addition, each VOA 22a-22d includes a top conducting electrode 40 on the top of the ridge 32 and one or more bottom conducting electrodes 42 along the upper semiconductor portion 39 of the substrate 30. The one or more bottom conducting electrodes 42 are located along or near one or both lateral boundaries of a corresponding one of the semiconductor ridges 32. The top and bottom electrodes 40, 42 are placed to enable application of a voltage across the electrical diode structure associated with the semiconductor ridge 32 during operation. The resulting electric field causes attenuation of an optical signal propagating along the ridge 32 of a VOA, e.g., via the Franz-Keldysh effect.

Since the VOAs 22a-22d are configured to attenuate light via the Franz-Keldesh effect, the illustrated vertical doping profile of the VOAs 22a-22d and the passive optical waveguides of FIGS. 2A-2B may be replaced by another vertical doping profile. In particular, in alternate embodiments, the p-i-n vertical doping profile of FIGS. 2A-2B may be replaced by either an n-i-n vertical doping profile or a p-i-p vertical doping profile.

FIG. 2C illustrates a cross-section of the layer structure in an embodiment of the photodetectors 24a-24b of FIG. 1A, e.g., along cross sections E-E and F-F therein. In this embodiment, each photodetector 24a-24b has a vertical layer structure of an electrical diode that includes the semiconductor layers of FIG. 2A as well as additional semiconductor layer(s) 43, 44. The additional layer(s) 43, 44 enable photo-excitation of charge carrier pairs to produce electrical currents or voltages for detecting light that is propagating in the photodiodes 24a-24b. For example, one or more of the additional semiconductor layers 43, 44 may be formed of a semiconductor alloy with a lower band gap energy than those of the ridge 32 in the passive optical waveguides illustrated by FIG. 2A. One or more of such different semiconductor alloys may have, e.g., a band gap that is smaller than the energy of a photon in the telecommunications C-band and/or L-band to enable operation as a photodetector in one of these telecommunications bands.

In FIG. 2C, the vertical layer structure of the photodiodes 24a-24b also typically includes a planarizing/outer-optical cladding layer 38 and top and bottom conducting electrodes 40, 42. The planarizing/outer-optical cladding layer 38 has a lower refractive index than the optical core and may or may not have the same composition as the outer cladding layer 38 of FIGS. 2A-2B. The top conducting electrode 40 is located on the top of the corresponding semiconductor ridge 32. The one or more bottom conducting electrodes 42 are located on the upper semiconductor layer 39 along or near one or both lateral boundaries of the corresponding semiconductor ridge 32.

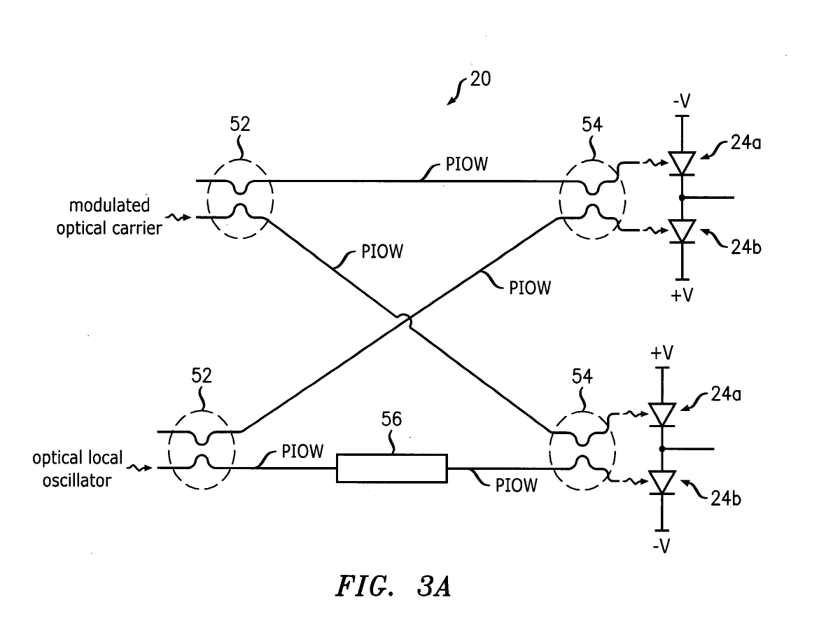

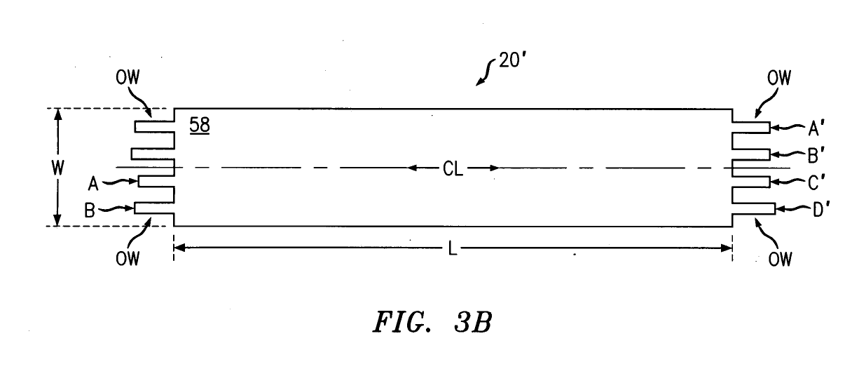

FIGS. 3A illustrates an example of a planar construction of a 90-degree optical hybrid 20 that may be suitable for the optical hybrids 20a, 20b of FIG. 1A. The optical hybrid 20 includes two 1×2 or 2×2 input optical couplers 52, two 2×2 output optical couplers 54, four passive internal optical waveguides PIOW, and a phase shifter 56. The four passive internal optical waveguides PIOW, separately connect optical outputs of the input optical couplers 52 to optical inputs of the output optical couplers 54. The phase shifter 56 is configured to cause a relative phase shift of about 90 degrees between the light of the reference optical carrier that is delivered to the first output optical coupler 52 and the second output optical coupler 54 and may be adjustable in some embodiments as described below. Due to the relative phase shift, the intensities of light from the optical outputs of the first and second output optical couplers 54 provide measures of the data modulated onto different phase components of the received modulated optical carrier, e.g., onto the in-phase and quadrature-phase components for a 90 degree relative phase shift. The various optical couplers 52, 54 may be conventional 50/50 optical couplers that direct about 50% of the received light intensity from each optical input to each optical output thereof. Each output optical coupler 54 transmits a sum of the two optical signals input therein to one optical output thereof and sends a difference of the two optical signals input therein to the other optical output thereof. The fabrication of such optical couplers 52, 54 is well-known to those of skill in the art.

In some embodiments, the phase delay 56, may be variable and controlled by an external controller (not shown) electrically or optically coupled thereto. For example, the external controller may make time-averaged measurements of the relative phase of the portions of the modulated optical carrier being sampled by the two different pairs of serially connected photodiodes 24a, 24b, e.g., based on light intensities measured by said pairs of photodiodes 24a, 24b. Such measurements may be feedback by such an external controller to adjust the phase delay 56 of the optical hybrid 20 during operation. Such feedback adjustment of the phase delay 56 can produce optical hybrids 20a, 20b that better discriminate phase components of the modulated optical carrier with relative phases of 90 degrees, e.g., the in-phase and quadrature-phase components.

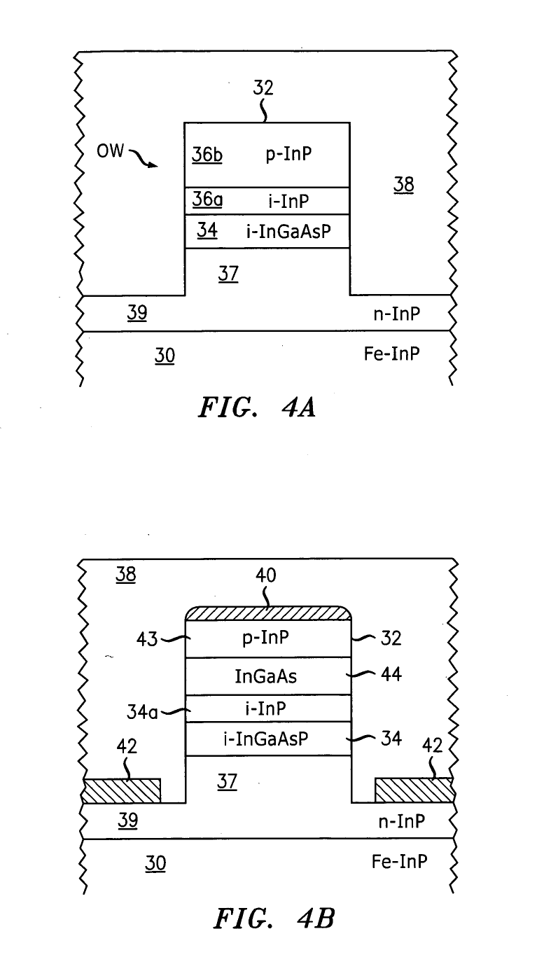

FIGS. 4A and 4B show one embodiment of optical and electrical components of FIGS. 2A and 2C. These embodiments may be fabricated on a crystalline compound semiconductor substrate 30 that is an electrically insulating or semi-insulating. Here, the substrate 30 may be a conventional indium phosphide (InP) substrate.

FIG. 4A illustrates an example of a vertical semiconductor layer structure for the passive optical waveguide structure of FIG. 2A. On an exemplary Fe-doped insulating or semi-insulating InP (Fe—InP) substrate 30, the bottom-to-top layer structure of the ridge 32 may include a bottom layer of n-type InP (n-InP) 37; a middle intrinsic layer of indium gallium arsenide phosphate (i-InGaAsP) 34, a middle intrinsic layer of indium phosphide (i-InP) 36a, and a top layer of p-type indium phosphide (p-InP) 36a. The combined bottom layer 39, 37 of n-InP has, e.g., a thickness of about 1.5 micrometers (μm) in the region in and under the ridge 32 and has an n-type dopant concentration of about 1×10¹⁸ silicon (Si) atoms per centimeter-cubed. The middle layer 34 of i-InGaAsP has, e.g., a thickness of 0.1 to 0.3 μm, e.g., about 0.17 μm. The middle layer 34 of i-InGaAsP 34 has an alloy composition that produces a bandgap larger than the energy of any single photon in the C-band of telecommunications, e.g., the bandgap may be the energy of a photon whose wavelength is 1.4 μm. The bandgap wavelength of the i-InGaAsP layer 34 is larger than that of InP, because the InGaAsP layer 34 serves as the core of the waveguide. The middle layer 36a of i-InP has, e.g., a thickness of about 0.450 μm to 0.500 μm. The top layer 36b of p-InP has, e.g., a thickness of about 1.3 μm and a p-type dopant concentration of about 1×10¹⁸ to 2×10¹⁸ zinc (Zn) atoms per centimeter-cubed.

In this example of the vertical semiconductor layer structure, both the InP layers and the InGaAsP layer are constructed to have bandgaps that are larger than the energies of single photons at the telecommunications wavelength at which the optical receiver 10 is configured to operate. For that reason, the passive optical waveguides of this embodiment are optically transparent at relevant optical communication wavelengths.

In this same embodiment, the passive optical waveguides, i.e., as illustrated in FIG. 2A, are covered by a passifying layer 38 of BCB, doped silicon dioxide, silicon nitride, or polyimide.

In this same embodiment, the optical hybrids 20a, 20b of FIG. 1A may have the same or a similar vertical semiconductor layer structure as that of FIG. 4A. For such a vertical semiconductor layer structure, FIG. 3B illustrates one embodiment 20′ for the optical hybrids 20a, 20b that is based on an optical multi-mode interference device.

The optical hybrid 20′ includes a rectangular free space optical region 58 with separate optical inputs for polarization maintaining optical waveguides, PMOW, at a first end thereof and four optical outputs for polarization maintaining optical waveguides, OW, at a second end thereof. For operating wavelengths in the C-band of optical telecommunications, the rectangular free space optical region 58 may have a length, L, of about 1.1 millimeters and a width, W, of about 24 μm. For such selected operating wavelength, the rectangular free space optical region 58 has optical inputs and outputs with lateral widths of about 4.0 μm. The optical inputs and outputs have the same sizes and placements at each end of the rectangular free space optical region 58 and are symmetrically placed about the centerline, CL, of the rectangular free space optical region 58. In particular, at the two ends of the rectangular free space optical region 58, the centers of two of the optical inputs and outputs are about 2.7 μm away from the centerline, CL, and the centers of the other two of the optical inputs and outputs are about 9.3 μm away from the centerline, CL.

The optical hybrid 20′ is configured to enable many modes to propagate in the rectangular free space optical region 58. In the operating wavelength range, the geometry of this embodiment of the optical hybrids 20a, 20b is such that a light beam of a data modulated optical carrier and a light beam of the reference optical carrier may be injected, i.e., from the left, into the optical inputs A and B, respectively. For this arrangement, a difference in light intensities from right-side optical outputs A′ and D′ can provide a measure of the in-phase component of the modulated optical carrier, and a difference in light intensities from right optical outputs B′ and C′ can provide a measure of the quadrature-phase component of the modulated optical carrier.

One skilled in the art would be able to modify the design of the optical hybrid 20′ of FIG. 3B to operate in another selected wavelength band, e.g., the L-band of optical telecommunications. For example, one such modification could involve scaling lateral dimensions of optical features of the optical hybrid 20 with a wavelength selected for operation.

In the same embodiment, the VOAs 22a-22d of FIG. 2B may also have the vertical semiconductor layer structure shown in FIG. 4A. The VOAs 22a-22d also have top and bottom conducting electrodes 40, 42. The top and bottom electrodes 40, 42 may be, e.g., formed of heavily doped InGaAs, e.g., doped with Si and Zn, respectively, at concentrations of about 1×10¹⁸ to 2×10¹⁹ Zn-atoms per centimeter-cubed or may be formed of metal layers.

FIG. 4B illustrates an example of a vertical semiconductor layer structure for photodiodes 24a-24b of FIG. 2C for the same embodiment of FIG. 4A. On the example Fe-doped InP substrate 30, the ridge 32 for the photodiodes 24a-24b has a vertical semiconductor layer structure that includes the bottom n-InP layer(s) 37, 39 and the middle i-InGaAsP layer 34 of FIG. 3A, i.e., i-type and n-type semiconductor layers of the passive optical waveguides. From bottom-to-top, the vertical semiconductor layer structure of the photodiodes 24a-24b next includes a thin spacer or barrier layer of i-InP 34a, a layer of InGaAs 44, a layer of p-type InP 43, and a top layer of heavily p-doped InGaAs 40. The spacer or barrier layer of i-InP 34a has, e.g., a thickness of about 0.010 μm. The layer of InGaAs 44 has, e.g., a thickness of about 0.300 μm. In the layer of InGaAs 44, the lower ⅔ is intrinsically-doped, and the upper ⅓ is p-type doped, e.g., with about 1×10¹⁷ Zn-atoms per centimeter-cubed. The p-type InP layer 43 has, e.g., a lower 0.100 μm thick portion that is doped with about 1×10¹⁸ Zn-atoms per centimeter-cubed and an upper 1.3 μm thick InP layer that is doped with about 1×10¹⁸ to 2×10¹⁸ Zn-atoms per centimeter-cubed. The top conducting layer 40 of heavily p-doped InGaAs may be doped with about 1×10¹⁹ Zn-atoms per centimeter-cubed.

With respect to FIGS. 3B and 4A-4B, the various structures may be formed with conventional deposition, compound semiconductor growth, doping, annealing, and mask-controlled etching processes that would be known to those of skill in the micro-electronics fabrication arts. In various processes, orders of layer growth and doping and the processes of etching may be performed in different orders to produce the illustrated semiconductor structures.

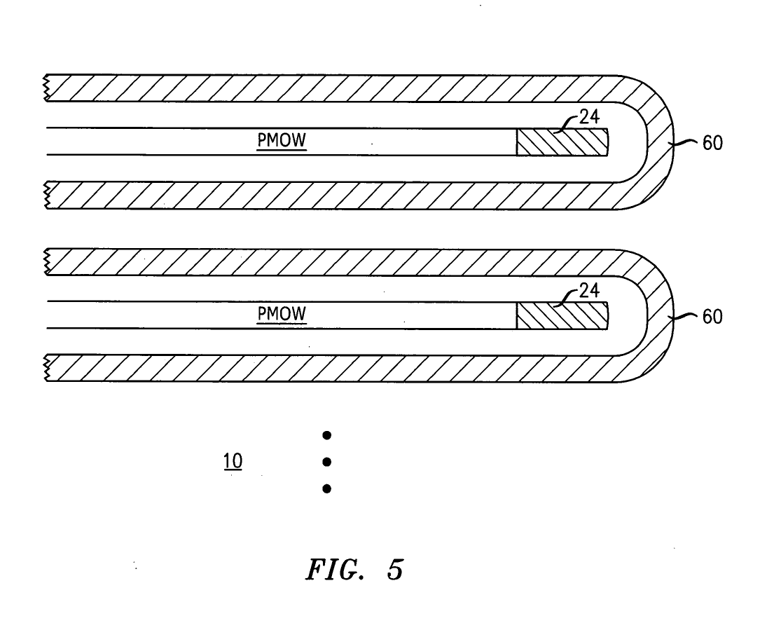

FIG. 5 illustrates an example construction for electrically isolating laterally adjacent photodiodes 24a, 24b of the optical receiver 10 of FIG. 1A and FIGS. 2A-2C. The construction includes etching an elongated U-shaped trench 60 around each photodiode 24a, 24b and the adjacent polarization maintaining optical waveguide PMOW coupled thereto. Each of the U-shaped trenches 60 passes through the intervening semiconducting layers, e.g., down to the insulating or semi-insulating substrate 30 of FIGS. 2A-2C. For that reason, the U-shaped trench 60 substantially blocks electrical paths for leakage currents between the different photodiodes 24.

In the embodiment of FIG. 5, there is still some leakage following the path of the polarization maintaining optical waveguides PMOW. Such leakage is small if the trenches 60 extend along long enough segments of the polarization maintaining optical waveguides PMOW, e.g., greater than 1 mm, and if the trench wall is sufficiently close to the waveguide, e.g., less than 7 microns. In such situations, the resistance of such leakage paths are high enough (e.g., greater than 1 kilo-ohm) to reduce electrical crosstalk between different photodiodes 24 to negligible levels.

With respect to FIG. 5, the U-shaped trenches 60 may be fabricated via conventional mask-controlled wet etching processes. For example, the wet etch may be performed with an aqueous solution of HBr and/or HCl, H₂O₂ and acetic acid.

From the disclosure, drawings, and claims, other embodiments of the invention will be apparent to those skilled in the art.

What is claimed is:

1. An optical receiver comprising:
a monolithically integrated electrical and optical circuit comprising a substrate with a planar surface, the circuit has along the planar surface, at least, an optical hybrid, one or more variable optical attenuators, and photodetectors; and
wherein the optical hybrid is connected to receive light beams, to interfere light of said received light beams with a plurality of relative phases and to output said interfered light via optical outputs thereof, each of the one or more variable optical attenuators connecting between a corresponding one of the optical outputs and a corresponding one of the photodetectors.

2. The optical receiver of claim 1,
wherein the integrated electrical and optical circuit comprises a polarization beam splitter located along the surface; and
wherein the optical receiver further comprises an optical local oscillator and the circuit is connected to receive light from said oscillator such that the polarization beam splitter splits said light into two light beams, the circuit being configured to perform said splitting without exchanging energy of said received light between transverse electric and transverse magnetic polarization modes.

3. The optical receiver of claim 1, further comprising a feedback controller connected to operate the variable optical attenuators to compensate a difference between a time-averaged light intensity delivered to one of the photodetectors by a first of the optical outputs of the optical hybrid and a time-averaged light intensity delivered to another of the photodetectors by a second of the optical outputs of the optical hybrid.

4. The apparatus of claim 1, wherein the optical hybrid includes a planar multi-mode interference device configured to output light intensities at different optical outputs thereof, the light intensities being indicative of different first and second phase components of a modulated optical carrier received by the optical receiver.

5. The optical receiver of claim 4, further comprising a feedback controller connected to operate a phase shifter in the optical hybrid in a manner that reduces an imbalance between time-averages of measurements of light intensities of in-phase and quadrature phase components of the modulated optical carrier by the photodetectors.

6. The optical receiver of claim 1,
wherein the circuit further comprises, along the planar surface, a pair of polarization beam splitters, a second optical hybrid, one or more second variable optical attenuators; and second photodetectors; and
wherein each of the second variable optical attenuators connects between a corresponding optical output of the second optical hybrid and a corresponding one of the second photodetectors; and
wherein each optical hybrid is connected to receive light from both polarization beam splitters.

7. The apparatus of claim 6, wherein each optical hybrid is configured to output one or more light beams whose intensities are indicative of data modulated onto an in-phase component a modulated optical carrier received by the optical receiver and a quadrature-phase component of the modulated optical carrier.

8. An apparatus, comprising:
a planar substrate having multiple layers of semiconductor located on a surface thereof, the layers being patterned to form two optical hybrids, a plurality of variable optical attenuators; and a plurality of photodetectors over said surface, some of the optical outputs of the optical hybrids being connected to corresponding ones of the photodetectors via the variable optical attenuators; and
wherein the optical hybrid and the variable optical attenuators include a vertical p-n, n-p, n-i-p, or p-i-n doped semiconductor layer structure therein.

9. The optical receiver of claim 8, wherein the variable optical attenuators include the vertical sequence of semiconductor alloys of the optical hybrids.

10. The optical receiver of claim 8, wherein the doped semiconductor layer structures of the optical hybrid and the variable optical attenuators are transparent to light at C-band telecommunications wavelengths in the absence of biasing.

11. The optical receiver of claim 8, wherein the photodetectors are photodiodes including a plurality of the semiconductor layers in the semiconductor layer structure in the optical hybrids.

12. The optical receiver of claim 8, further comprising:
first and second polarization beam splitters located along and over the surface, each polarization beam splitter being configured to transmit one polarization component of light received therein to a first of the optical hybrids and to transmit another polarization component of light received therein to a second of the optical hybrids.

13. An optical receiver comprising:
a monolithically integrated electrical and optical circuit comprising a substrate with a planar surface, the circuit including two polarization beam splitters, two optical hybrids, and photodetectors located along the surface; and
wherein each optical hybrid is connected to receive light beams from both polarization beam splitters, to interfere light of said received light beams and to output said interfered light via optical outputs thereof to some of the photodetectors; and
wherein each polarization beam splitter includes an interferometer, the interferometer including an input optical coupler, an output optical coupler, and two internal optical waveguides connecting optical outputs of the input optical coupler to corresponding optical inputs of the output optical coupler, the two optical waveguides having different lateral widths.

14. The optical receiver of claim 13, wherein the interferometer is configured to emit one polarization mode at one optical output thereof and to emit a different polarization mode at another output thereof.

15. The optical receiver of claim 13, wherein one of the optical hybrids includes a planar multi-mode interference device configured to output light intensities at different optical outputs thereof, the light intensities being indicative of different first and second phase components of a modulated optical carrier received by the optical receiver.

16. The optical receiver of claim 13, wherein the optical hybrids include a vertical p-n, n-p, n-i-p, or p-i-n doped semiconductor layer structure therein.

17. An optical receiver comprising:
a monolithically integrated electrical and optical circuit having a substrate with a planar surface, the circuit including, along the surface, two polarization beam splitters, two optical hybrids, and photodetectors; and
an optical local oscillator being connected to receive a reference optical carrier from the optical local oscillator in a polarization mode not aligned with either polarization splitting axis of a one of the polarization beam splitters connected to receive the reference optical carrier.

18. The optical receiver of claim 17, wherein a part of the circuit that receives the reference optical carrier from the optical local oscillator and separates different polarization modes thereof is configured to not substantially transfer light energy thereof between a transverse magnetic mode and a transverse electric mode.

19. The optical receiver of claim 17, wherein each optical hybrid is connected to receive light beams from both polarization beam splitters, to interfere said received light beams, and to output said interfered light via optical outputs thereof.

20. The optical receiver of claim 17, wherein one of the optical hybrids includes a planar multi-mode interference device configured to output light intensities at different optical outputs thereof, the light intensities being indicative of different first and second phase components of a modulated optical carrier received by the optical receiver.
